(19) United States
(12) Patent Application Publication
(10) Pub. No.: US 2025/0337063 A1
(43) Pub. Date: Oct. 30, 2025

(54) METHOD OF MANUFACTURING SECONDARY BATTERY AND SECONDARY BATTERY

(71) Applicant: Prime Planet Energy & Solutions, Inc., Tokyo (JP)

(72) Inventor: Kazuki TAMURA, Takasago-shi (JP)

(21) Appl. No.: 19/186,620

(22) Filed: Apr. 23, 2025

(30) Foreign Application Priority Data
Apr. 25, 2024 (JP) 2024-071396

(51) Int. Cl. H01M 50/169; H01M 50/15

(52) U.S. Cl. CPC H01M 50/169; H01M 50/15

(57) ABSTRACT

A method of manufacturing a secondary battery includes: positioning a case main body and a sealing plate so as to provide a level difference between an edge portion of the case main body and an outer end surface of the sealing plate in a first direction; and when the level difference is defined as H1, a maximum clearance between an opening and the outer end surface in a second direction orthogonal to the first direction is defined as L, and an inclination angle of an optical axis of laser light with respect to the first direction is defined as θ, joining portions of the case main body and the sealing plate by applying the laser light to the edge portion and the outer end surface with the optical axis being inclined at an angle equal to or more than a numerical value of θ that satisfies a relation of tan θ=L/H1.

### CROSS REFERENCE TO RELATED APPLICATIONS

This nonprovisional application is based on Japanese Patent Application No. 2024-071396 filed on Apr. 25, 2024 with the Japan Patent Office, the entire contents of which are hereby incorporated by reference.

### BACKGROUND OF THE INVENTION

### Field of the Invention

The present technology relates to: a method of manufacturing a secondary battery; and the secondary battery.

### Description of the Background Art

Japanese Patent Laying-Open No. 2018-202478 is a prior art document that discloses a configuration of a laser sealing apparatus. The laser sealing apparatus described in Japanese Patent Laying-Open No. 2018-202478 seals an opening of a container using a laser beam with a lid being provided at the opening of the container. The laser beam is divided into a first laser beam and a second laser beam. The first laser beam is applied to the vicinity of a joining surface of the opening of the container. The second laser beam is applied to the vicinity of a joining surface of the lid. Since the laser beams are less likely to be applied to the joining surfaces, occurrence of sputter at each of the joining surfaces is suppressed.

### SUMMARY OF THE INVENTION

In the laser sealing apparatus described in Japanese Patent Laying-Open No. 2018-202478, when a clearance between a case main body and a sealing plate is larger than the position of application of the divided laser light, the laser light may enter inside of a battery from between the case main body and the sealing plate, i.e., so-called laser penetration may occur. In this case, the laser light is applied to an electrode assembly in the battery, with the result that the electrode assembly in the battery may be damaged.

The present technology has been made to solve the above problem, and has an object to provide a method of manufacturing a secondary battery and the secondary battery so as to attain suppression of occurrence of laser penetration when joining a case main body and a sealing plate.

The present technology provides the following method of manufacturing a secondary battery.

[1]

A method of manufacturing a secondary battery, the method comprising:
preparing an electrode assembly, a case main body, and a sealing plate, the case main body having an edge portion defining an opening at one end of the case main body in a first direction, the sealing plate being able to seal the opening;
accommodating the electrode assembly into the case main body through the opening;
positioning the case main body and the sealing plate so as to provide a level difference between the edge portion and an outer end surface of the sealing plate opposite to an inner end surface of the sealing plate facing the electrode assembly in the first direction; and
when the level difference is defined as H1, a maximum clearance between the opening and the outer end surface in a second direction orthogonal to the first direction is defined as L, and an inclination angle of an optical axis of laser light with respect to the first direction is defined as θ,
joining portions of the case main body and the sealing plate by applying the laser light to the edge portion and the outer end surface with the optical axis being inclined at an angle equal to or more than a numerical value of θ that satisfies a relation of tan θ=L/H1.
   [2]

The method of manufacturing a secondary battery according to [1], wherein
in the joining the portions of the case main body and the sealing plate,
   the level difference H1 is 0.3 mm or more and 1.4 mm or less,
   the maximum clearance L is 0.05 mm or more and 0.2 mm or less, and
   the inclination angle θ is 2° or more and 10° or less and satisfies the relation of tan θ=L/H1.
      [3]

The method of manufacturing a secondary battery according to [1] or [2], wherein
in the positioning the case main body and the sealing plate,
   the outer end surface is disposed at a position away from the electrode assembly with respect to the edge portion in the first direction.
      [4]

The method of manufacturing a secondary battery according to any one of [1] to [3], wherein
the edge portion includes a first portion located on an outer peripheral side and a second portion located on an inner peripheral side,
the first portion is provided to protrude to an outer side of the case main body with respect to the second portion in the first direction, and
in the positioning the case main body and the sealing plate, the second portion and the sealing plate are in abutment with each other in the first direction.

The present technology provides the following secondary battery.

[5]

A secondary battery comprising:
an electrode assembly;
a case main body that accommodates the electrode assembly, the case main body having an edge portion defining an opening at one end of the case main body in a first direction; and
a sealing plate that seals the opening, the sealing plate including an inner end surface facing the electrode assembly and an outer end surface opposite to the inner end surface, wherein
the opening has a shape allowing the electrode assembly to be inserted through the opening,
a joining portion is formed to join the edge portion and the outer end surface,
a level difference is provided between an end portion of the joining portion and the outer end surface in the first direction, and
the level difference is 0.23 mm or more and is 1/7 or less of a thickness of the sealing plate in the first direction.
   [6]

The secondary battery according to [5], wherein the outer end surface is located away from the electrode assembly with respect to the edge portion in the first direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a configuration of a secondary battery according to a first embodiment of the present technology.

FIG. 2 is a cross sectional view of a configuration around a joining portion between a case main body and a sealing plate in FIG. 1 as viewed in a direction of arrow II-II.

FIG. 3 is a flowchart showing a method of manufacturing the secondary battery according to the first embodiment of the present technology.

FIG. 4 is a perspective view showing a state in which an electrode assembly is inserted into a case main body.

FIG. 5 is a cross sectional view showing a state in which the case main body and the sealing plate are positioned in the first embodiment of the present technology.

FIG. 6 is a top view showing positions at each of which the case main body and the sealing plate are temporarily joined.

FIG. 7 is a cross sectional view showing a positional relation among the case main body, the sealing plate, and an inclination angle of laser when temporarily joining the case main body and the sealing plate in the first embodiment of the present technology.

FIG. 8 is a cross sectional view showing the inclination angle of the laser light when temporarily joining the case main body and the sealing plate.

FIG. 9 is a cross sectional view showing a positional relation among a case main body, a sealing plate, and an inclination angle of laser when temporarily joining the case main body and the sealing plate in a comparative example.

FIG. 10 is a graph showing a test result of checking whether or not laser penetration has occurred when joining the case main body and the sealing plate in accordance with a correlation among a first level difference, a maximum clearance, and the inclination angle of the laser.

FIG. 11 is a graph showing a region in which no laser penetration occurs when joining the case main body and the sealing plate in accordance with a correlation between a laser application angle and the first level difference in each clearance between the case main body and the sealing plate.

FIG. 12 is a cross sectional view showing the configuration of the joining portion between the case main body and the sealing plate in the first embodiment of the present technology.

FIG. 13 is a graph showing a correlation between the first level difference and a second level difference.

FIG. 14 is a cross sectional view showing a positional relation among a case main body, a sealing plate, and an inclination angle of laser when temporarily joining the case main body and the sealing plate in a second embodiment of the present technology.

FIG. 15 is a cross sectional view showing a state in which a case main body and a sealing plate are positioned in a third embodiment of the present technology.

FIG. 16 is a flowchart showing a method of manufacturing a secondary battery according to the third embodiment of the present technology.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “secondary battery” is not limited to a lithium ion battery, and may include other secondary batteries such as a nickel-metal hydride battery and a sodium-ion battery. In the present specification, the term “electrode” may collectively represent a positive electrode and a negative electrode.

Further, the “secondary battery” can be mounted on vehicles such as a hybrid electric vehicle (HEV), a plug-in hybrid electric vehicle (PHEV), and a battery electric vehicle (BEV). It should be noted that the purpose of use of the “secondary battery” is not limited to the use on a vehicle.

It should be noted that in each of the figures, an X direction is defined as a direction in which a positive electrode terminal and a negative electrode terminal of the secondary battery are arranged side by side, a Y direction is defined as a direction in which a first side surface portion and a second side surface portion of a case are arranged side by side, and a Z direction serving as a first direction is defined as a direction of line perpendicular to a plane in which a main surface of an outer end surface of a sealing plate extends. Further, a second direction is defined as a direction parallel to the plane in which the main surface of the outer end surface of the sealing plate extends. Further, in the figures, the scale of each of constituent members of the secondary battery may be changed or part of the constituent members may be omitted in schematic illustration for the sake of convenience.

### First Embodiment

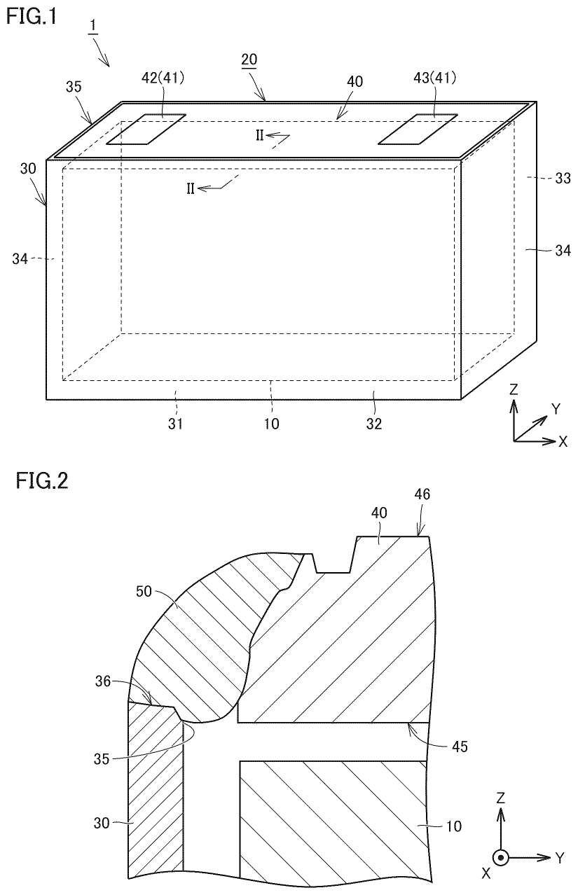

First, an overall structure of a secondary battery will be described. FIG. 1 is a perspective view showing a configuration of a secondary battery according to a first embodiment of the present technology.

As shown in FIG. 1, a secondary battery 1 has a prismatic shape. Secondary battery 1 is, for example, a lithium ion battery. Secondary battery 1 according to the first embodiment of the present technology includes an electrode assembly 10 and a case 20.

Electrode assembly 10 in the present embodiment is, for example, a wound type electrode assembly. Further, electrode assembly 10 is not limited to the wound type electrode assembly, and may be a stack type electrode assembly.

Electrode assembly 10 includes a positive electrode, a negative electrode, and separators, which are not shown in the figure. Each of the positive electrode, the negative electrode, and the separators is a sheet in the form of a strip. A separator is interposed between the positive electrode and the negative electrode. Electrode assembly 10 is formed by winding a stack of the positive electrode, the negative electrode, and the separators. A separator is disposed at the outermost periphery of electrode assembly 10 wound.

Case 20 has a rectangular parallelepiped shape and forms an appearance of secondary battery 1. Case 20 accommodates electrode assembly 10 and an electrolyte solution (not shown). Case 20 is composed of, for example, an aluminum alloy.

Case 20 includes a case main body 30 and a sealing plate 40. Case main body 30 accommodates electrode assembly 10.

Case main body 30 has a bottom surface portion 31, a first side surface portion 32, a second side surface portion 33, and a third side surface portion 34.

Bottom surface portion 31 is constituted of a plane orthogonal to the Z direction. Bottom surface portion 31 faces sealing plate 40 in the Z direction.

Each of first side surface portion 32 and second side surface portion 33 is constituted of a plane orthogonal to the Y direction. First side surface portion 32 and second side surface portion 33 face each other in the Y direction. Each of first side surface portion 32 and second side surface portion 33 has the largest area among the plurality of side surfaces of case main body 30. Each of first side surface portion 32 and second side surface portion 33 has a rectangular shape as viewed in the Y direction. Each of first side surface portion 32 and second side surface portion 33 has a rectangular shape in which the X direction corresponds to the long-side direction and the Z direction corresponds to the short-side direction as viewed in the Y direction. Each of first side surface portion 32 and second side surface portion 33 is provided to rise from bottom surface portion 31.

Each of third side surface portions 34 is constituted of a plane orthogonal to the X direction. The pair of third side surface portions 34 are provided in secondary battery 1. The pair of third side surface portions 34 are arranged side by side in the X direction. The pair of third side surface portions 34 are provided to rise from bottom surface portion 31. Each of the pair of third side surface portions 34 connects end portions of first side surface portion 32 and second side surface portion 33.

An opening 35 described later is formed in case main body 30. Opening 35 is formed by the end portions of first side surface portion 32, second side surface portion 33, and the pair of third side surface portions 34 in the Z direction. Opening 35 has a shape allowing electrode assembly 10 to be inserted therethrough.

Sealing plate 40 is a flat plate extending on the XY plane. Sealing plate 40 seals opening 35.

Sealing plate 40 is provided with an electrode terminal 41. The electrode terminal has a positive electrode terminal 42 and a negative electrode terminal 43. Positive electrode terminal 42 and negative electrode terminal 43 are provided to be separated from each other in the X direction. Positive electrode terminal 42 and negative electrode terminal 43 are joined to a bus bar (not shown) by laser welding or the like.

A plurality of secondary batteries 1 are arranged side by side in the Y direction. The plurality of secondary batteries 1 are stacked such that first side surface portions 32 face each other and second side surface portions 33 face each other between secondary batteries 1, 1 adjacent to each other in the Y direction. Thus, positive electrode terminals 42 and negative electrode terminals 43 are alternately arranged in the Y direction in which the plurality of secondary batteries 1 are stacked.

FIG. 2 is a cross sectional view of a configuration around a joining portion between the case main body and the sealing plate in FIG. 1 as viewed in a direction of arrow 1I-II.

Case main body 30 has a post-joining edge portion 36. Post-joining edge portion 36 defines opening 35 at one end of case main body 30 in the first direction (Z direction). Post-joining edge portion 36 in the present embodiment is an interface between a joining portion 50 (portion at which the case main body and the sealing plate are melted together) and a portion constituted only of case main body 30.

Sealing plate 40 includes an inner end surface 45 and an outer end surface 46. Inner end surface 45 is a surface located on the inner space side of case main body 30. Inner end surface 45 extends on the XY plane. Inner end surface 45 faces electrode assembly 10.

Outer end surface 46 is a surface located on the outer side of secondary battery 1. Outer end surface 46 extends on the XY plane. Outer end surface 46 is located opposite to inner end surface 45 in the first direction (Z direction). Outer end surface 46 is located away from electrode assembly 10 with respect to edge portion 36 in the first direction (Z direction).

Joining portion 50 is formed in case 20. Joining portion 50 joins edge portion 36 and outer end surface 46. Joining portion 50 is formed by a below-described pre-joining edge portion 37 of case main body 30 and outer edge portion 49 of sealing plate 40 being melted together.

The thickness of sealing plate 40 in the first direction (Z direction) is preferably equal to or more than the joining depth of joining portion 50 and three times or more as large as a first level difference H1 described later. Thus, during the joining between case main body 30 and sealing plate 40, joining portion 50 is not melted to fall into the inside of case main body 30, and a joining range between case main body 30 and sealing plate 40 can be sufficiently secured.

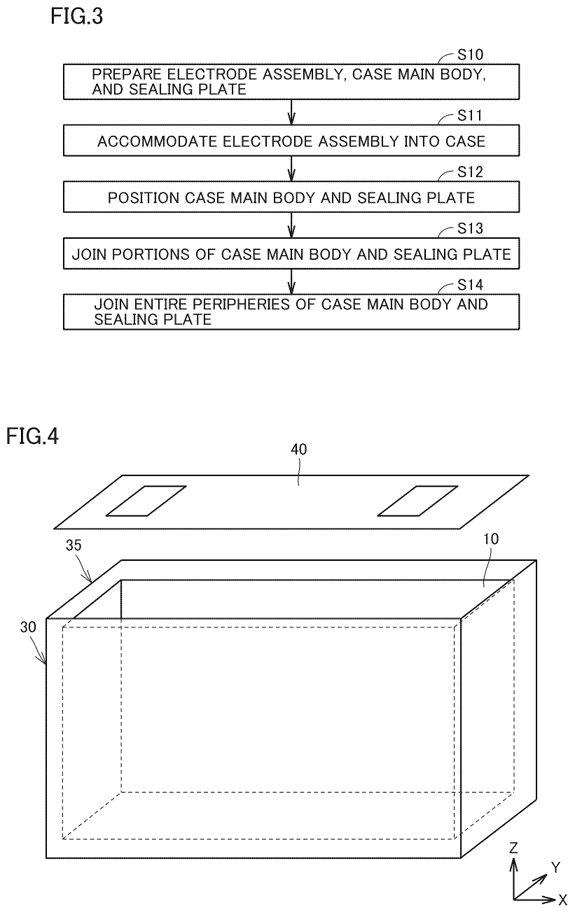

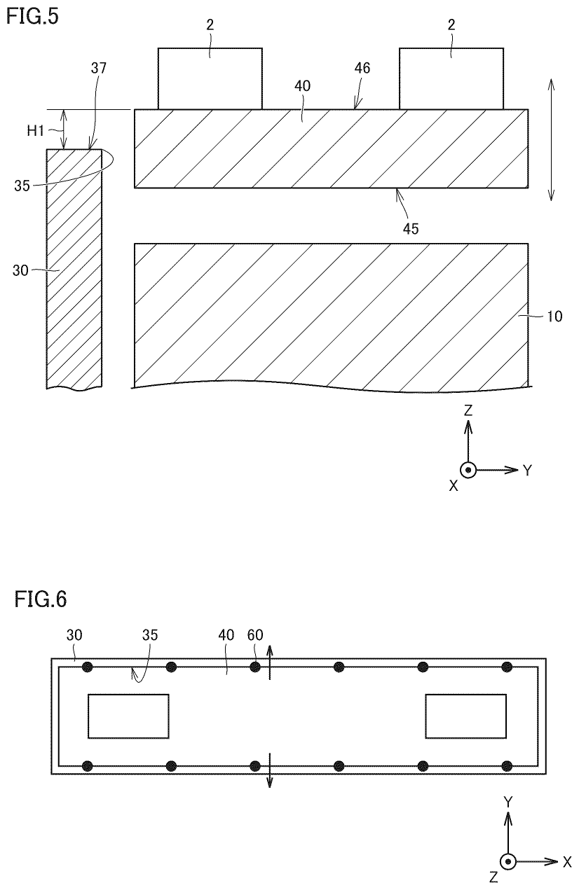

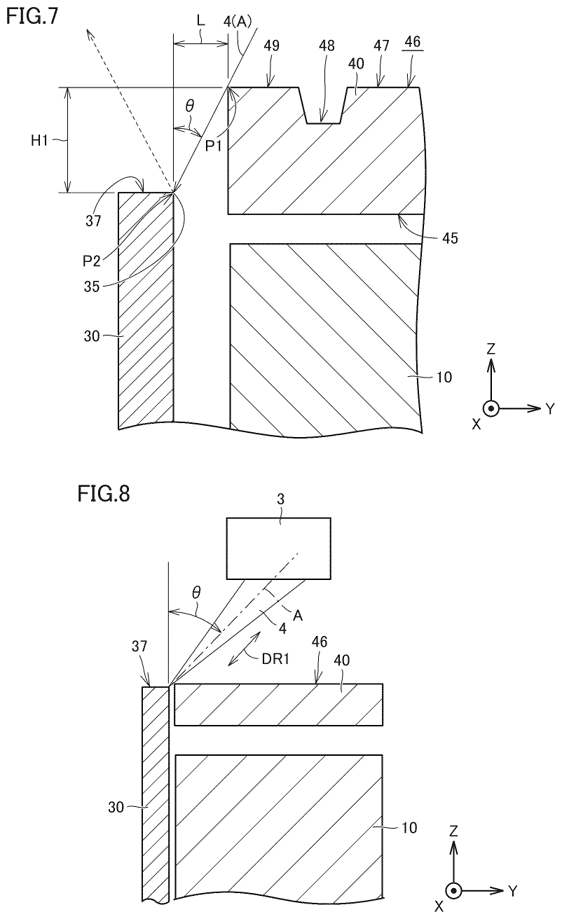

Hereinafter, a method of manufacturing secondary battery 1 according to the first embodiment of the present technology will be described. FIG. 3 is a flowchart showing the method of manufacturing the secondary battery according to the first embodiment of the present technology. FIG. 4 is a perspective view showing a state in which the electrode assembly is inserted into the case main body. FIG. 5 is a cross sectional view showing a state in which the case main body and the sealing plate are positioned in the first embodiment of the present technology. FIG. 6 is a top view showing positions at each of which the case main body and the sealing plate are temporarily joined. FIG. 7 is a cross sectional view showing a positional relation among the case main body, the sealing plate, and an inclination angle of laser when temporarily joining the case main body and the sealing plate in the first embodiment of the present technology. FIG. 8 is a cross sectional view showing the inclination angle of the laser light when temporarily joining the case main body and the sealing plate.

As shown in FIGS. 3 to 5, first, electrode assembly 10, case main body 30, and sealing plate 40 are prepared (step S10). Pre-joining edge portion 37 is formed in case main body 30. Pre-joining edge portion 37 defines opening 35 at one end in the first direction (Z direction). Pre-joining edge portion 37 is a portion located at an end portion of case main body 30 in the first direction (Z direction) in a state before case main body 30 and sealing plate 40 are joined to each other. Sealing plate 40 is formed to have a shape to seal opening 35.

Next, as shown in FIGS. 3 and 4, electrode assembly 10 is accommodated into case main body 30 through opening 35 (step S11).

Next, as shown in FIGS. 3 and 5, case main body 30 and sealing plate 40 are positioned (step S12). Specifically, case main body 30 and sealing plate 40 are positioned to provide first level difference H1 between pre-joining edge portion 37 and outer end surface 46 of sealing plate 40 in the first direction (Z direction).

Case main body 30 is fixed to a jig (not shown). Sealing plate 40 is held by a holding apparatus 2. Holding apparatus 2 holds sealing plate 40 while suctioning outer end surface 46 of sealing plate 40 using, for example, an air suction pad. When positioning sealing plate 40, the position thereof may be recognized by a camera (not shown).

In the step (step S12) of positioning case main body 30 and sealing plate 40 in the present embodiment, outer end surface 46 is disposed at a position away from electrode assembly 10 with respect to pre-joining edge portion 37 in the first direction (Z direction).

Next, as shown in FIGS. 3 and 6, portions of case main body 30 and sealing plate 40 are joined (step S13). That is, case main body 30 and sealing plate 40 are temporarily joined to each other. Case main body 30 and sealing plate 40 are temporarily joined to each other by applying laser light thereto.

Case main body 30 and sealing plate 40 are temporarily joined to each other by a plurality of temporary joining portions 60. The plurality of temporary joining portions 60 are disposed at intervals at a location at which case main body 30 and sealing plate 40 are expected to be joined. Each of temporary joining portions 60 is formed by moving the laser light by about 1 mm from the sealing plate 40 side toward the case main body 30 side (direction of arrow in FIG. 6).

Examples of parameters to be taken into consideration when temporarily joining case main body 30 and sealing plate 40 include: the first level difference between pre-joining edge portion 37 and outer end surface 46; a maximum clearance between opening 35 and outer end surface 46; and an inclination angle of the optical axis of the laser light with respect to the first direction (Z direction).

As shown in FIG. 7, first level difference H1 is a level difference before case main body 30 and sealing plate 40 are joined to each other. Specifically, first level difference H1 is a level difference between pre-joining edge portion 37 and outer end surface 46 of sealing plate 40 in the first direction (Z direction).

Reference positions for the first level difference are the inner end portion of pre-joining edge portion 37 in case main body 30, and the outermost edge portion of outer end surface 46 in sealing plate 40.

A clearance may be formed between case main body 30 and sealing plate 40 due to a dimensional tolerance of each of case main body 30 and sealing plate 40, deformation resulting from pressing when case main body 30 or sealing plate 40 is held, or the like. The size of the clearance is varied in the peripheral direction in which case main body 30 and sealing plate 40 are joined. As shown in FIG. 7, the maximum clearance between opening 35 and outer end surface 46 in the second direction (Y direction in the cross section shown in FIG. 7) orthogonal to the first direction is defined as L.

As with the reference positions for first level difference H1, reference positions for maximum clearance L are the inner end portion of pre-joining edge portion 37 in case main body 30, and the outermost edge portion of outer end surface 46 in sealing plate 40.

As shown in FIGS. 7 and 8, a laser oscillator 3 oscillates laser light 4. Laser light 4 is inclined with respect to the first direction (Z direction). The inclination angle of optical axis A of laser light 4 with respect to the first direction is defined as θ.

As shown in FIG. 8, a direction (DR1 direction) in which optical axis A extends is parallel to a line segment connecting the center of the width of laser light 4 immediately after being emitted from laser oscillator 3 and the center of the width of laser light 4 at a position of edge portion 37 or outer end surface 46 to which laser light 4 is applied. Inclination angle θ is an inclination angle of the direction (DR1 direction) in which optical axis A extends with respect to the first direction (Z direction). In the present embodiment, optical axis A of laser light 4 is inclined from the sealing plate 40 side toward the joining position of edge portion 37 or outer end surface 46.

As shown in FIG. 7, in the present embodiment, outer end surface 46 is provided with a main surface portion 47, a recess 48, and an outer edge portion 49. Main surface portion 47 occupies a large part of outer end surface 46. Main surface portion 47 and outer edge portion 49 are partitioned from each other by recess 48 formed on the outer peripheral side of main surface portion 47. Each of temporary joining portions 60 is formed by pre-joining edge portion 37 of case main body 30 and outer edge portion 49 of sealing plate 40 being melted together.

Since recess 48 is provided, heat generated on the outer edge portion 49 side is less likely to be transferred to the main surface portion 47 side, with the result that heat of laser light 4 is facilitated to be concentrated on outer edge portion 49 to melt outer edge portion 49. When first level difference H1 is large, the heat of laser light 4 is facilitated to be concentrated on outer edge portion 49 even if outer edge portion 49 is deviated from the focal point of laser light 4, with the result that outer edge portion 49 is facilitated to be melted. Thus, temporary joining portion 60 is readily formed.

When joining the portions of case main body 30 and sealing plate 40, laser light 4 is applied to pre-joining edge portion 37 and outer end surface 46 with optical axis A being inclined at an angle equal to or more than a numerical value of θ that satisfies a relation of tan θ=L/H1, thereby joining the portions of case main body 30 and sealing plate 40. Laser light 4 after being applied to edge portion 37 and outer end surface 46 is reflected to outside of case main body 30.

Inclination angle θ in the present embodiment indicates an angle at which laser light 4 hits an innermost end portion P2 of edge portion 37 when laser light 4 is applied from an end portion P1 of outer edge portion 49 toward pre-joining edge portion 37. Therefore, when inclination angle θ is a value larger than θ that satisfies tan θ=L/H1, laser light 4 is applied from end portion P1 of outer edge portion 49 of sealing plate 40 to the outer side with respect to innermost end portion P2 of edge portion 37, with the result that laser light 4 is avoided from heading toward maximum clearance L.

In the step of joining the portions of case main body 30 and sealing plate 40 in the present embodiment, level difference H1 is, for example, 0.3 mm or more and 1.4 mm or less. Maximum clearance L is, for example, 0.05 mm or more and 0.2 mm or less. Inclination angle θ is, for example, 2° or more and 10° or less, and satisfies the relation of tan θ=L/H1.

Next, the entire peripheries of case main body 30 and sealing plate 40 are joined (step S14). That is, case main body 30 and sealing plate 40 are permanently joined to each other. Case main body 30 and sealing plate 40 are permanently joined to each other by applying laser light 4 thereto. Since case main body 30 and sealing plate 40 are permanently joined to each other, opening 35 is sealed by sealing plate 40.

As a condition for the permanent joining, the beam diameter of laser light 4 is, for example, 0.8 mm or more and 1.0 mm or less at a position of each of edge portion 36 and outer end surface 46 to which laser light 4 is applied. The output of laser light 4 is, for example, 6000 W. The traveling speed of laser light 4 at the time of the joining is, for example, 300 mm/s. Inclination angle θ is, for example, 0°.

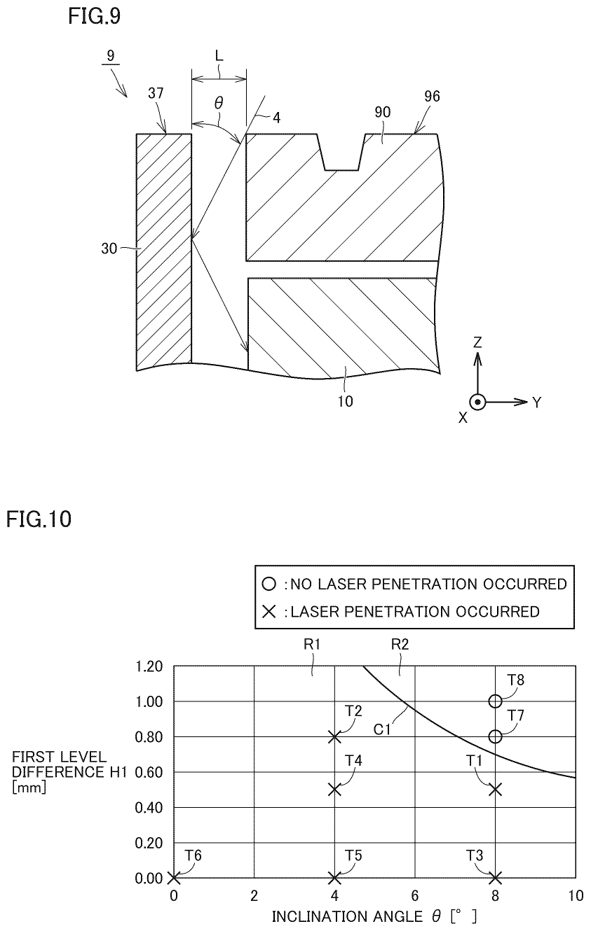

Here, temporary joining between a case main body and a sealing plate in a secondary battery according to a comparative example will be described. FIG. 9 is a cross sectional view showing a positional relation among the case main body, the sealing plate, and an inclination angle of laser when temporarily joining the case main body and the sealing plate in the comparative example.

As shown in FIG. 9, in a method of manufacturing secondary battery 9 according to the comparative example, case main body 30 and sealing plate 90 are positioned such that pre-joining edge portion 37 and outer end surface 96 of sealing plate 90 are located at substantially the same position in the first direction (Z direction).

In the temporary joining between case main body 30 and sealing plate 90 according to the comparative example, laser light 4 is applied at same inclination angle θ as in the first embodiment. Laser light 4 enters the inside of case main body 30 from maximum clearance L between case main body 30 and sealing plate 90. That is, in the temporary joining between case main body 30 and sealing plate 90 according to the comparative example, the laser penetration occurs. When the laser penetration occurs in case main body 30, electrode assembly 10 is damaged due to laser light 4 applied to electrode assembly 10. In this comparative example, the separator of electrode assembly 10 is damaged.

On the other hand, as shown in FIG. 7, in secondary battery 1 according to the first embodiment, first level difference H1 is provided in the temporary joining. By providing first level difference H1, a path through which laser light 4 inclined at inclination angle θ enters the inside of case main body 30 is blocked by outer end surface 46 of sealing plate 40. Thus, laser light 4 can be suppressed from entering the inside of case main body 30. That is, in the temporary joining between case main body 30 and sealing plate 40 according to the present embodiment, the laser penetration can be suppressed. As a result, the damage of electrode assembly 10 is suppressed. In the present embodiment, the damage of the separator of electrode assembly 10 is suppressed.

A checking test was performed with regard to whether or not the occurrence of the laser penetration to the inside of case main body 30 was suppressed by the above-described configuration of secondary battery 1 according to the present embodiment. FIG. 10 is a graph showing a test result of checking whether or not the laser penetration has occurred when joining the case main body and the sealing plate in accordance with a correlation among the first level difference, the maximum clearance, and the inclination angle of the laser.

As a test condition, the beam diameter of laser light 4 was 0.6 mm at a position of each of edge portion 36 and outer end surface 46 to which laser light 4 was applied. The output of laser light 4 was 3000 W. The traveling speed of laser light 4 during the joining was 150 mm/s. Inclination angle θ was 0° or more and 8° or less. Inclination angle θ was found from a calculation value with a target position being adjusted. First level difference H1 was 0 mm or more and 1 mm or less. Maximum clearance L was 0.1 mm. Maximum clearance L was estimated from tolerances of case main body 30 and sealing plate 40 at the time of manufacturing. Maximum clearance L was formed by sandwiching a shim between case main body 30 and sealing plate 40.

The test was performed with various first level differences H1 and inclination angles θ being set. In a test T1, when first level difference H1 was 0.5 mm and inclination angle θ was 8°, the laser penetration occurred. “X” indicates that the laser penetration occurred. Similarly, in each of tests T2 to T6, the laser penetration occurred.

On the other hand, in a test T7, when first level difference H1 was 0.8 mm and inclination angle θ was 8°, no laser penetration occurred. “O” indicates that no laser penetration occurred. No laser penetration occurred also in a test T8.

In view of each of the above test results, a relation with a curve C1 shown in FIG. 10 was checked. Curve C1 indicates tan θ=0.1/H1 obtained by substituting L=0.1 into the formula of tan θ=L/H1.

A region corresponding to an angle less than the numerical value of θ that satisfies the relation of tan θ=0.1/H1 is a region R1 indicated by tan θ<0.1/H1. In each of tests T1 to T6 included in region R1, the laser penetration occurred. On the other hand, a region corresponding to an angle equal to or more than the numerical value of θ that satisfies the relation of tan θ=0.1/H1 is a region R2 indicated by tan θ≥0.1/H1. In each of tests T7 and T8 included in region R2, no laser penetration occurred. Thus, it was confirmed that whether or not the laser penetration occurs was changed based on curve C1 as a boundary line.

FIG. 11 is a graph showing a region in which no laser penetration occurs when joining the case main body and the sealing plate in accordance with a correlation between the laser application angle and the first level difference in each clearance between the case main body and the sealing plate.

As shown in FIG. 11, curve C1 indicates tan θ=0.1/H1 with the maximum clearance being 0.1 mm. A curve C2 indicates tan θ=0.05/H1 with the maximum clearance being 0.05 mm. A curve C3 indicates tan θ=0.2/H1 with the maximum clearance being 0.2 mm.

In addition to region R2 described above, a region corresponding to an angle equal to or more than a numerical value of θ that satisfies a relation of tan θ=0.05/H1 is a region R3 indicated by tan θ≥0.05/H1. A region corresponding to an angle equal to or more than a numerical value of θ that satisfies a relation of tan θ=0.2/H1 is a region R4 indicated by tan θ≥0.2/H1.

When the maximum clearance is 0.05 mm, the occurrence of the laser penetration is suppressed under the condition for region R3. When the maximum clearance is 0.2 mm, the occurrence of the laser penetration is suppressed under the condition for region R4.

First level difference H1, maximum clearance L between case main body 30 and sealing plate 40, and inclination angle θ of optical axis A of laser light 4 are set to satisfy tan θ=L/H, and laser light 4 is applied at an angle equal to or more than inclination angle θ, thereby suppressing the occurrence of the laser penetration in the temporary joining between case main body 30 and sealing plate 40. The occurrence of the laser penetration is suppressed by increasing first level difference H1 and inclination angle θ as maximum clearance L is larger.

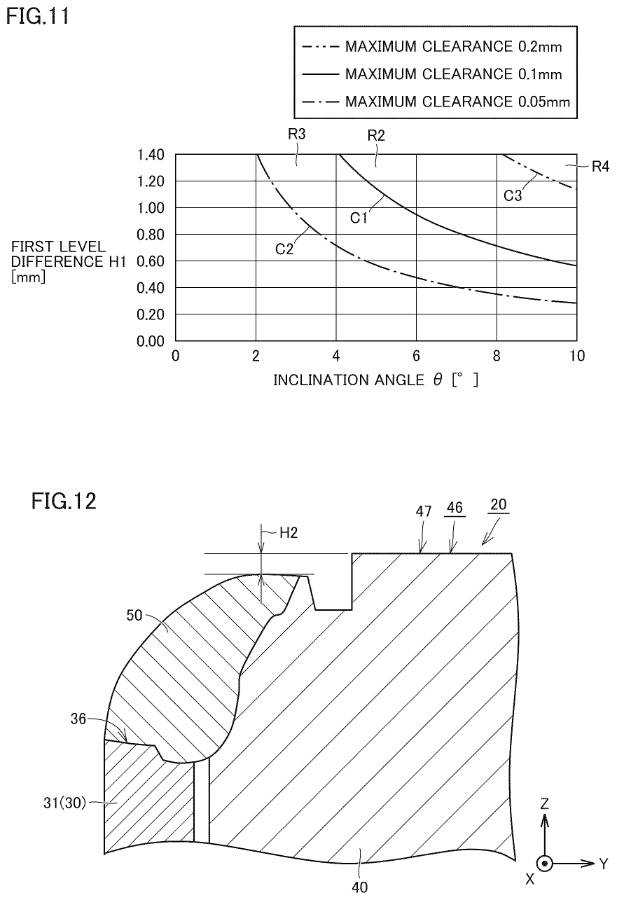

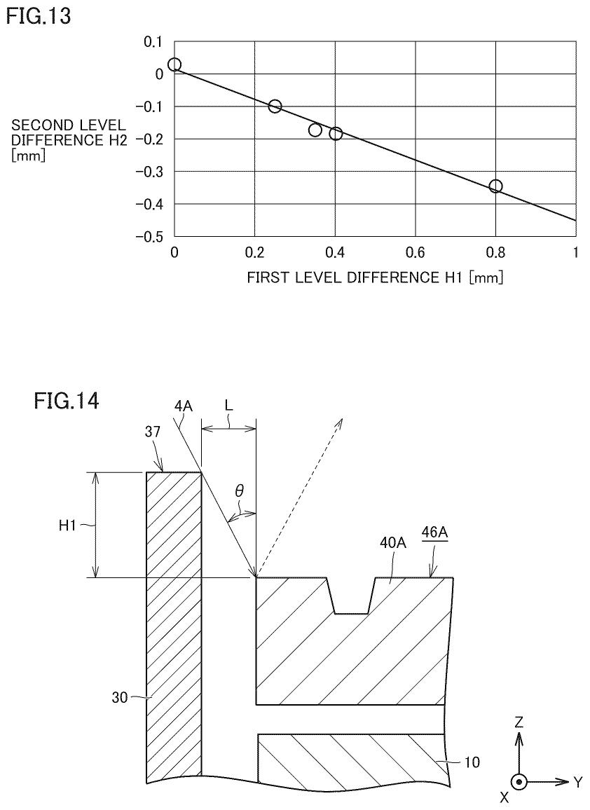

Next, a correlation between first level difference H1 before the joining between case main body 30 and sealing plate 40 and a second level difference after the joining therebetween will be described. FIG. 12 is a cross sectional view showing the configuration of the joining portion between the case main body and the sealing plate in the first embodiment of the present technology. FIG. 13 is a graph showing a correlation between the first level difference and the second level difference.

As shown in FIG. 12, a second level difference H2 is provided in case 20 after the temporary joining and the permanent joining. Second level difference H2 is a level difference between the end portion of joining portion 50 and outer end surface 46 in the first direction (Z direction). Reference positions for second level difference H2 are the end portion of joining portion 50 in the first direction in joining portion 50, and main surface portion 47 included in outer end surface 46 in sealing plate 40.

Second level difference H2 is, for example, −0.3 mm, assuming that second level difference H2 becomes negative in value in a downward direction with respect to outer end surface 46 when the temporary joining is performed with the first level difference being 0.8 mm and then the entire peripheries are permanently joined.

As shown in FIG. 13, second level differences H2 with respect to various first level differences H1 were checked. In FIG. 13, “O” indicates results of checking second level differences H2 with respect to various first level differences H1. The correlation between first level difference H1 and second level difference H2 is indicated by a straight line approximate to y=−0.44x, where x represents the first level difference and y represents the second level difference.

Second level difference H2 in the present embodiment is 0.23 mm or more when expressed as an absolute value, and is 1/7 or less of the thickness of sealing plate 40 in the first direction (Z direction).

The range of second level difference H2 is preferably determined by the thickness of sealing plate 40. As described above, the first level difference (x) and the second level difference (y) have the relation of y=−0.44x in view of the test results.

When the thickness of the sealing plate is defined as t, the thickness (t) of the sealing plate is preferably three times or more as large as the first level difference (x). Therefore, x=(⅓)t is established. By substituting this formula into y=−0.44x, y=−0.44x×((⅓)t)≈−( 1/7)t is obtained.

When second level difference H2 is expressed as an absolute value, the upper limit value of second level difference H2 is varied depending on the thickness of the sealing plate. For this reason, as the upper limit value of second level difference H2, there is used y=( 1/7)t, which is obtained by expressing y=−( 1/7)t, which is a relational formula between the second level difference (y) and the thickness (t) of the sealing plate, as an absolute value.

When second level difference H2 is indicated as an absolute value, the lower limit value of second level difference H2 is calculated from the minimum thickness of sealing plate 40. Since the joining depth of joining portion 50 is 1.6 mm, the thickness of sealing plate 40 needs to be at least 1.6 mm. When the thickness of the sealing plate is 1.6 mm, t=1.6 is substituted into y=−( 1/7)t, which is the relational formula between the second level difference (y) and the thickness (t) of the sealing plate, thereby obtaining y=−0.23. Therefore, the lower limit value of second level difference H2 is y=0.23, which is obtained by expressing y=−0.23 as an absolute value.

In the method of manufacturing secondary battery 1 according to the first embodiment of the present technology, when temporarily joining case main body 30 and sealing plate 40, first level difference H1 is provided at the position of joining between case main body 30 and sealing plate 40, and optical axis A of laser light 4 is inclined at inclination angle θ. Thus, laser light 4 to enter the inside of case main body 30 from maximum clearance L is blocked by first level difference H1, thereby suppressing the occurrence of the laser penetration when temporarily joining case main body 30 and sealing plate 40. As a result, it is possible to improve robustness (property less prone to an external influence such as the clearance) against the clearance formed between case main body 30 and sealing plate 40 at the time of the temporary joining.

In the method of manufacturing secondary battery 1 according to the first embodiment of the present technology, even when there are various maximum clearances L between case main body 30 and sealing plate 40, first level difference H1 and inclination angle θ of optical axis A of laser light 4 are set in accordance with the size of each maximum clearance L, thereby suppressing the laser penetration when temporarily joining case main body 30 and sealing plate 40.

In the method of manufacturing secondary battery 1 according to the first embodiment of the present technology, each of temporary joining portions 60 is formed by moving laser light 4 by about 1 mm from the sealing plate 40 side toward the case main body 30 side (direction of arrow in FIG. 6). Thus, laser light 4 can be sufficiently applied to pre-joining edge portion 37 and outer edge portion 49 so as to secure the joining depth while suppressing laser light 4 from entering the clearance between case main body 30 and sealing plate 40, thereby temporarily joining case main body 30 and sealing plate 40 securely.

In each of the method of manufacturing secondary battery 1 and secondary battery 1 according to the first embodiment of the present technology, the inner space of case main body 30 can be increased by disposing outer end surface 46 at a position away in the first direction (Z direction) from electrode assembly 10 with respect to pre-joining edge portion 37 or post-joining edge portion 36. Thus, the volume occupied by electrode assembly 10 in case main body 30 can be increased, thus resulting in improved performance of secondary battery 1.

In secondary battery 1 according to the first embodiment of the present technology, since first level difference H1, which is 0.23 mm or more and is 1/7 or less of the thickness of sealing plate 40, is provided between outer end surface 46 of sealing plate 40 and the end portion of joining portion 50 between case main body 30 and sealing plate 40, the laser penetration can be suppressed when temporarily joining case main body 30 and sealing plate 40. Accordingly, the damage of the separator of electrode assembly 10 can be suppressed.

### Second Embodiment

Hereinafter, a method of manufacturing a secondary battery and the secondary battery according to a second embodiment of the present technology will be described. Since the method of manufacturing the secondary battery and the secondary battery according to the second embodiment of the present technology are different from the method of manufacturing secondary battery 1 and secondary battery 1 according to the first embodiment of the present technology in terms of the configuration of the sealing plate and the direction of application of the laser light, the same configurations as those in the method of manufacturing secondary battery 1 and secondary battery 1 according to the first embodiment of the present technology will not be described repeatedly.

FIG. 14 is a cross sectional view showing a positional relation among the case main body, the sealing plate, and the inclination angle of the laser when temporarily joining the case main body and the sealing plate in the second embodiment of the present technology.

As shown in FIG. 14, when temporarily joining case main body 30 and a sealing plate 40A in the second embodiment of the present technology, sealing plate 40A is disposed close to electrode assembly 10 with respect to pre-joining edge portion 37 of case main body 30. Laser light 4A is inclined from the case main body 30 side toward the joining position of edge portion 37 or an outer end surface 46A.

In the method of manufacturing the secondary battery and the secondary battery according to the second embodiment of the present technology, when the Z direction is the height direction, the position of sealing plate 40A becomes low, with the result that the height of the secondary battery can be low.

### Third Embodiment

Hereinafter, a secondary battery according to a third embodiment of the present technology will be described. Since the secondary battery according to the third embodiment of the present technology is different from secondary battery 1 according to the first embodiment of the present technology in terms of the configuration of the case main body and the method of positioning the case main body and the sealing plate, the same configurations as those of secondary battery 1 according to the first embodiment of the present technology will not be described repeatedly.

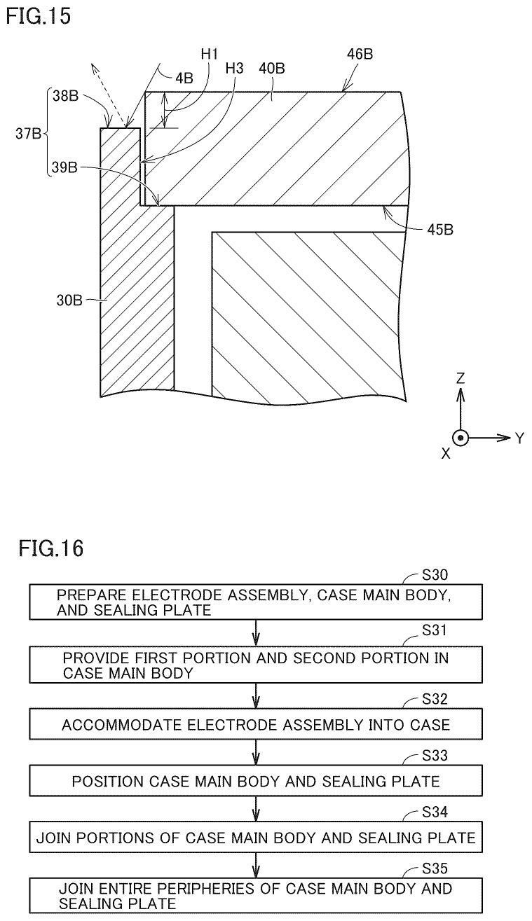

FIG. 15 is a cross sectional view showing a state in which the case main body and the sealing plate are positioned in the third embodiment of the present technology. FIG. 16 is a flowchart showing a method of manufacturing the secondary battery according to the third embodiment of the present technology.

As shown in FIG. 15, a pre-joining edge portion 37B according to the present embodiment includes a first portion 38B and a second portion 39B. First portion 38B is located on the outer peripheral side of a case main body 30B. Second portion 39B is located on the inner peripheral side of case main body 30B. A third level difference portion H3 is formed between first portion 38B and second portion 39B. Thus, first portion 38B is provided to protrude to the outer side of case main body 30B with respect to second portion 39B in the first direction (Z direction).

As shown in FIG. 16, electrode assembly 10, case main body 30, and sealing plate 40B are prepared (step S30). Case main body 30B is provided with first portion 38B and second portion 39B (step S31). Thereafter, electrode assembly 10 is accommodated into case main body 30B (step S32).

As shown in FIGS. 15 and 16, in the step (step S33) of positioning case main body 30B and sealing plate 40B, second portion 39B and inner end surface 45B of sealing plate 40B are in abutment with each other in the first direction (Z direction).

In a state in which second portion 39B and sealing plate 40B are in abutment with each other in the first direction (Z direction), the temporary joining and the permanent joining are performed between pre-joining edge portion 37B and outer end surface 46B (steps S34 and S35).

In each of the method of manufacturing the secondary battery and the secondary battery according to the third embodiment of the present technology, since first portion 38B protruding with respect to second portion 39B is provided at pre-joining edge portion 37B, case main body 30B and sealing plate 40B can be positioned to bring second portion 39B and sealing plate 40B into abutment with each other in the first direction (Z direction). Thus, case main body 30B and sealing plate 40B can be positioned without using a holding apparatus that holds sealing plate 40B. Moreover, since first level difference H1 can be provided without an influence of variation in operation of the manufacturing apparatus, case main body 30B and sealing plate 40B can be stably positioned.

In the method of manufacturing the secondary battery according to the third embodiment of the present technology, since third level difference portion H3 is formed, second portion 39B and inner end surface 45B of sealing plate 40B are facilitated to be brought into close contact with each other, with the result that the laser penetration can be suppressed.

It should be noted that it does not mean that the first level difference in each of the above-described embodiments is a level difference caused by the manufacturing tolerances of the case main body and the sealing plate when a state in which no level difference is provided between the case main body and the sealing plate is employed as a designed value.

Further, in the permanent joining between the case main body and the sealing plate in each of the above-described embodiments, no inclination angle is provided to the laser light. When a start point of application of the laser light in the permanent joining is arranged at the location at which the temporary joining has been performed, the laser penetration at the start of the joining is prevented. Thereafter, when joining the entire peripheries, the joining locations are sequentially melted to block the laser light by the joining locations themselves, with the result that no laser penetration occurs.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A method of manufacturing a secondary battery, the method comprising:
preparing an electrode assembly, a case main body, and a sealing plate, the case main body having an edge portion defining an opening at one end of the case main body in a first direction, the sealing plate being able to seal the opening;
accommodating the electrode assembly into the case main body through the opening;
positioning the case main body and the sealing plate so as to provide a level difference between the edge portion and an outer end surface of the sealing plate opposite to an inner end surface of the sealing plate facing the electrode assembly in the first direction; and
when the level difference is defined as H1, a maximum clearance between the opening and the outer end surface in a second direction orthogonal to the first direction is defined as L, and an inclination angle of an optical axis of laser light with respect to the first direction is defined as θ,
joining portions of the case main body and the sealing plate by applying the laser light to the edge portion and the outer end surface with the optical axis being inclined at an angle equal to or more than a numerical value of θ that satisfies a relation of tan θ=L/H1.

2. The method of manufacturing a secondary battery according to claim 1, wherein
in the joining the portions of the case main body and the sealing plate,
the level difference H1 is 0.3 mm or more and 1.4 mm or less,
the maximum clearance L is 0.05 mm or more and 0.2 mm or less, and
the inclination angle θ is 2° or more and 10° or less and satisfies the relation of tan θ=L/H1.

3. The method of manufacturing a secondary battery according to claim 1, wherein
in the positioning the case main body and the sealing plate,
the outer end surface is disposed at a position away from the electrode assembly with respect to the edge portion in the first direction.

4. The method of manufacturing a secondary battery according to claim 2, wherein
in the positioning the case main body and the sealing plate,
the outer end surface is disposed at a position away from the electrode assembly with respect to the edge portion in the first direction.

5. The method of manufacturing a secondary battery according to claim 1, wherein
the edge portion includes a first portion located on an outer peripheral side and a second portion located on an inner peripheral side,
the first portion is provided to protrude to an outer side of the case main body with respect to the second portion in the first direction, and
in the positioning the case main body and the sealing plate, the second portion and the sealing plate are in abutment with each other in the first direction.

6. The method of manufacturing a secondary battery according to claim 2, wherein
the edge portion includes a first portion located on an outer peripheral side and a second portion located on an inner peripheral side,
the first portion is provided to protrude to an outer side of the case main body with respect to the second portion in the first direction, and
in the positioning the case main body and the sealing plate, the second portion and the sealing plate are in abutment with each other in the first direction.

7. A secondary battery comprising:
an electrode assembly;
a case main body that accommodates the electrode assembly, the case main body having an edge portion defining an opening at one end of the case main body in a first direction; and
a sealing plate that seals the opening, the sealing plate including an inner end surface facing the electrode assembly and an outer end surface opposite to the inner end surface, wherein
the opening has a shape allowing the electrode assembly to be inserted through the opening,
a joining portion is formed to join the edge portion and the outer end surface,
a level difference is provided between an end portion of the joining portion and the outer end surface in the first direction, and
the level difference is 0.23 mm or more and is 1/7 or less of a thickness of the sealing plate in the first direction.

8. The secondary battery according to claim 7, wherein the outer end surface is located away from the electrode assembly with respect to the edge portion in the first direction.
